(19) United States
(12) Patent Application Publication
(10) Pub. No.: US 2011/0017671 A1
(43) Pub. Date: Jan. 27, 2011

(54) WATER TREATMENT SYSTEM AND METHOD

(76) Inventors: ERNEST ROBERTS ALLEY, JR., Nashville, TN (US); Matthew T. Tanner, Nashville, TN (US)

Correspondence Address: W. EDWARD RAMAGE, COMMERCE CENTER SUITE 1000, 211 COMMERCE ST, NASHVILLE, TN, 37201, US

(21) Appl. No.: 12/690,619

(22) Filed: Jan. 20, 2010

Related U.S. Application Data
(60) Provisional application No. 61/145,802, filed on Jan. 20, 2009.

(51) Int. Cl. C02F 1/42; B01D 15/04; B01D 35/143; B01D 37/04; C02F 101/22; C02F 103/06

(52) U.S. Cl. 210/662; 210/196; 210/85; 210/688

(57) ABSTRACT

A water treatment apparatus and system, comprising a treatment tank with a plurality of flow-through containers filled with iron shavings. The water is recirculated through the containers of iron shavings in series to treat contaminants, including but not limited to hexavalent chrome. The hexavalent chrome is converted to trivalent chrome via electron transfer between the iron molecules and the chrome molecules. The hydraulic detention time (circulation time) can vary.

This application claims priority to U.S. Provisional Application No. 61/114,802, entitled “Water Treatment System and Method,” filed on Jan. 20, 2010, and is entitled, in whole or in part, to that filing date. The complete disclosure, specification, drawings and attachments of U.S. Provisional Application No. 61/114,802 are incorporated herein by specific reference for all purposes.

### FIELD OF INVENTION

The present invention relates to a system and method for treating water. More specifically, the present invention relates to a system and method for treating process water and ground water to remove contaminants, including but not limited to hexavalent chrome.

### SUMMARY OF INVENTION

In one exemplary embodiment, water to be treated (e.g., process wastewater, contaminated groundwater, or the like) is held in a holding tank. The water is transferred from the holding tank into the treatment tank, which comprises one or more containers 6 filled in whole or in part with iron shavings. The containers may be 55-gallon drums, but may be of any suitable size, shape or composition.

The water is recirculated through the containers of iron shavings in series to treat contaminants. In one exemplary embodiment, the contaminant being treated is hexavalent chrome. The hexavalent chrome is converted to trivalent chrome via electron transfer between the iron molecules and, in this case, the chrome molecules. The hydraulic detention time (circulation time) can vary. In one exemplary embodiment, total recirculation time is approximately 8 hours.

The treated water is discharged from the treatment tank. In one exemplary embodiment, the discharge water is circulated through a final container (e.g., 55-gallon drum) with iron shavings as a final stage to prevent system breakthrough. In another embodiment, the final container is located inside the treatment tank. The discharge stream between the treatment tank and the final container, or beyond the final container and outside the treatment tank, or both, may be monitored to record performance of the system, such as through a sampling port, and to indicate when “spent” iron shaving drums need to be replaced.

### BRIEF DESCRIPTION OF THE DRAWINGS

FIG. 1 shows a top plan view of a treatment system in accordance with one embodiment of the present invention.

FIG. 2 shows a top plan view of a treatment system in accordance with another embodiment of the present invention.

FIG. 3 shows a side profile view of a component of a treatment system in accordance with one embodiment of the present invention.

### DETAILED DESCRIPTION OF EXEMPLARY EMBODIMENTS

The present invention relates to a specific water treatment application. The process is based upon the reactive properties of zero-valent iron (in one exemplary embodiment referred to as “iron shavings”), which has been applied to the treatment of contaminated waters in a variety of different applications and methods.

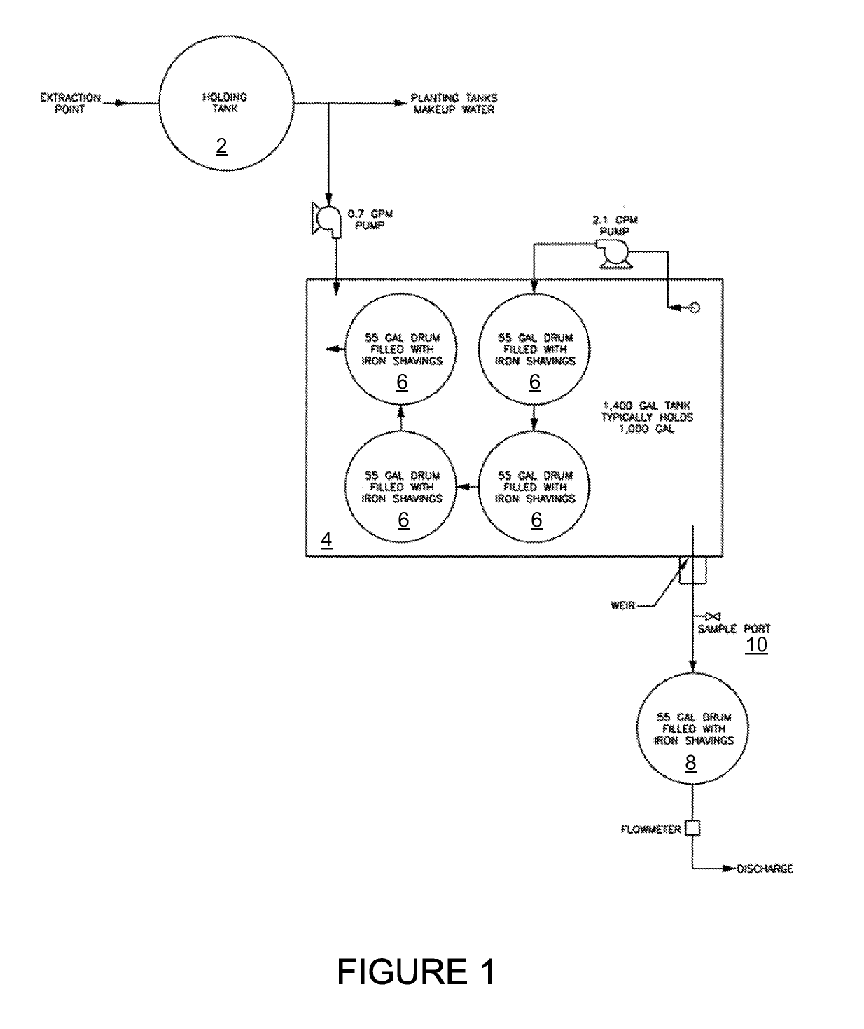

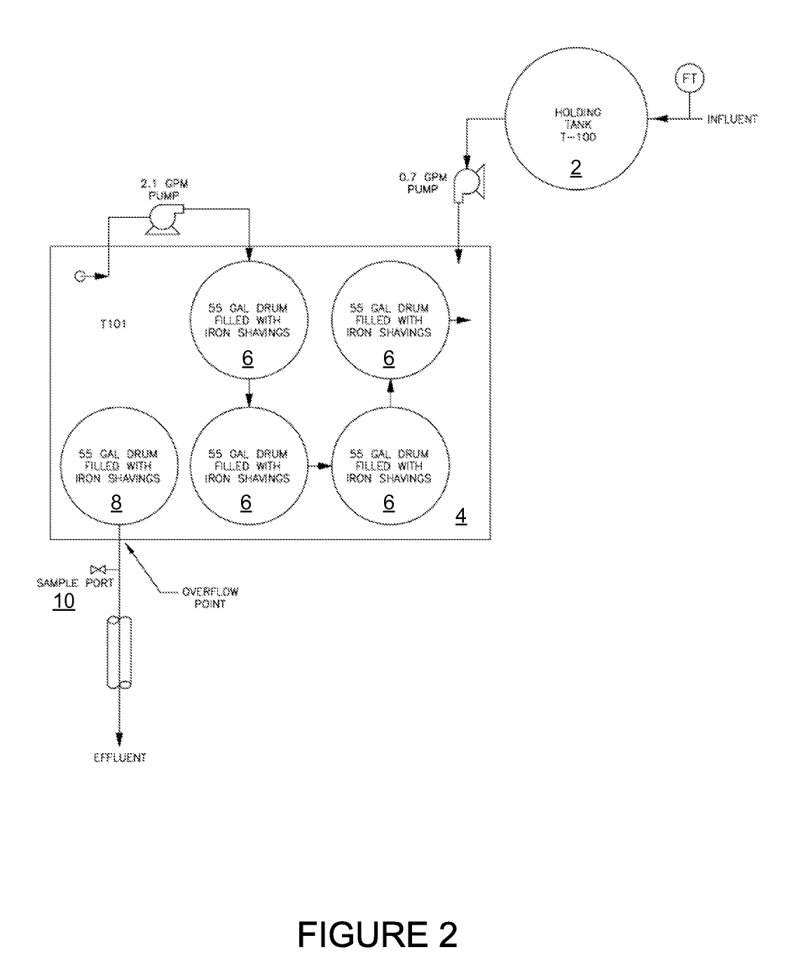

In one exemplary embodiment, as shown in FIGS. 1 and 2, water to be treated is held in a holding tank 2. The water to be treated may be process wastewater, contaminated groundwater from a remedial action, or the like. The water is transferred from the holding tank 2 into the treatment tank 4, which comprises one or more containers 6 filled in whole or in part with iron shavings. The containers may be 55-gallon drums, but may be of any suitable size, shape or composition.

The water is recirculated through the containers of iron shavings in series to treat contaminants. In one exemplary embodiment, the contaminant being treated is hexavalent chrome. The hexavalent chrome is converted to trivalent chrome via electron transfer between the iron molecules and, in this case, the chrome molecules. The hydraulic detention time (circulation time) can vary. In one exemplary embodiment, total recirculation time is approximately 8 hours.

The treated water is discharged from the treatment tank 4. In one exemplary embodiment, the discharge water is circulated through a final container 8 (e.g., 55-gallon drum) with iron shavings as a final stage to prevent system breakthrough. In another embodiment, the final container 8 is located inside the treatment tank (as seen in FIG. 2). The discharge stream between the treatment tank 4 and the final container 8 (as seen in FIG. 1), or beyond the final container and outside the treatment tank (as seen in FIG. 2), or both, may be monitored to record performance of the system, such as through a sampling port 10, and to indicate when “spent” iron shaving drums need to be replaced.

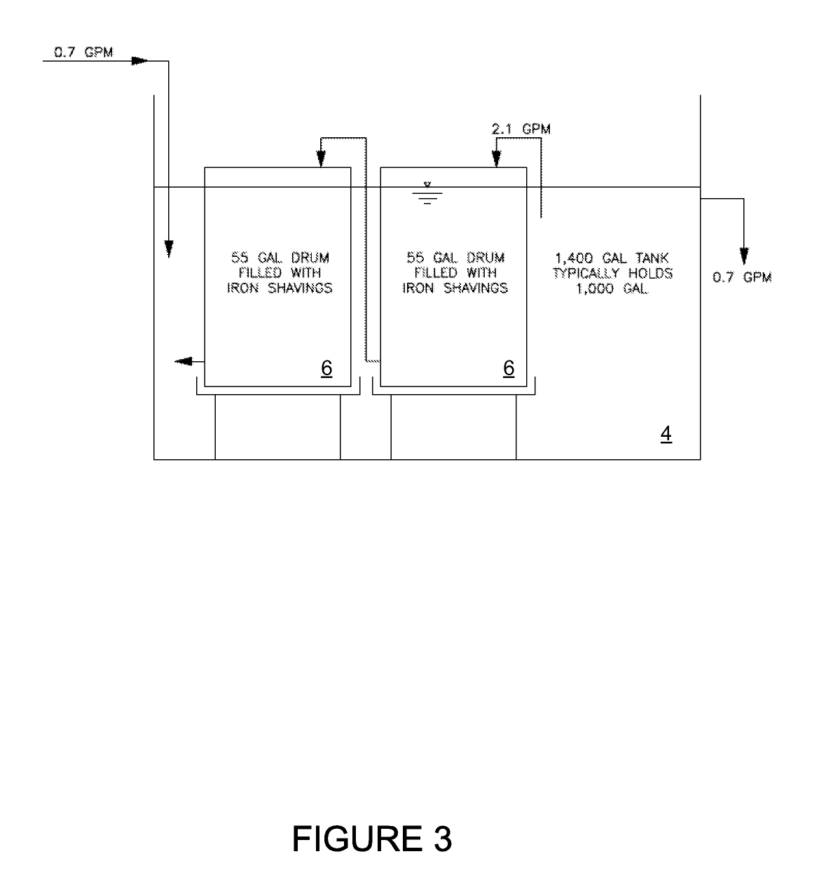

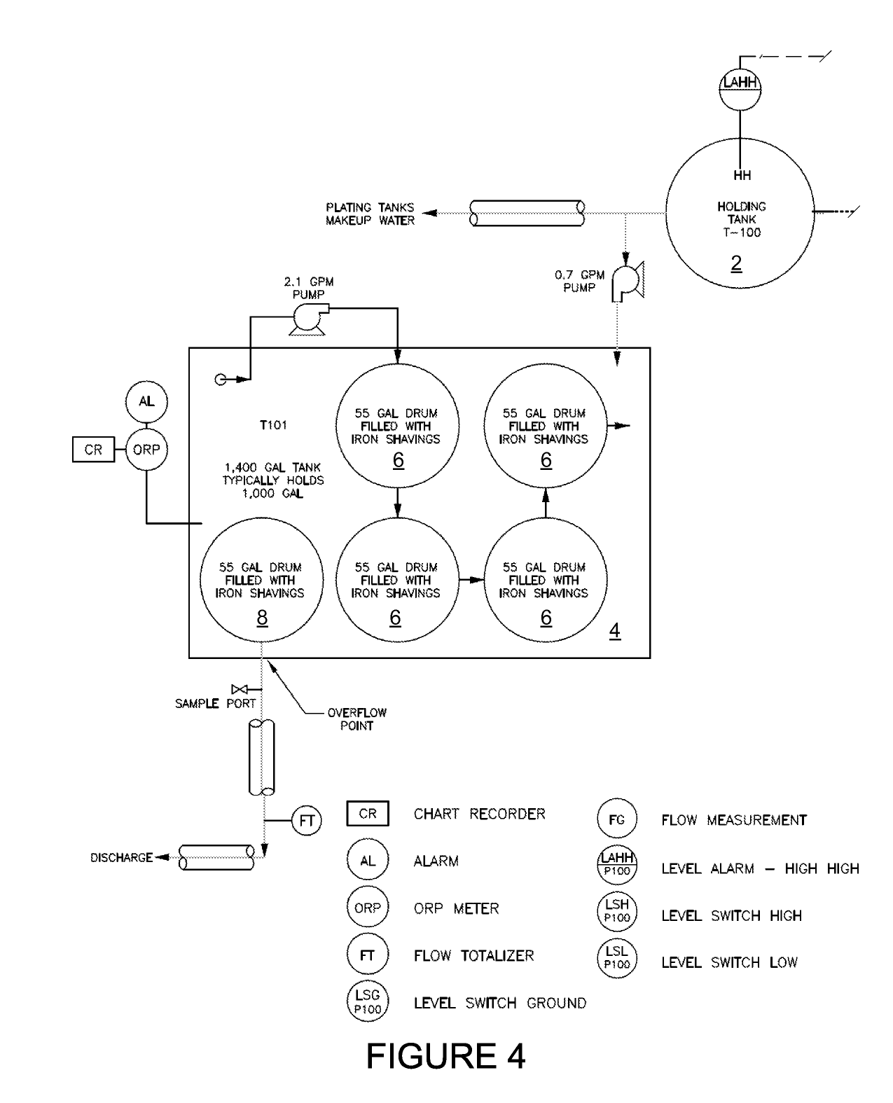

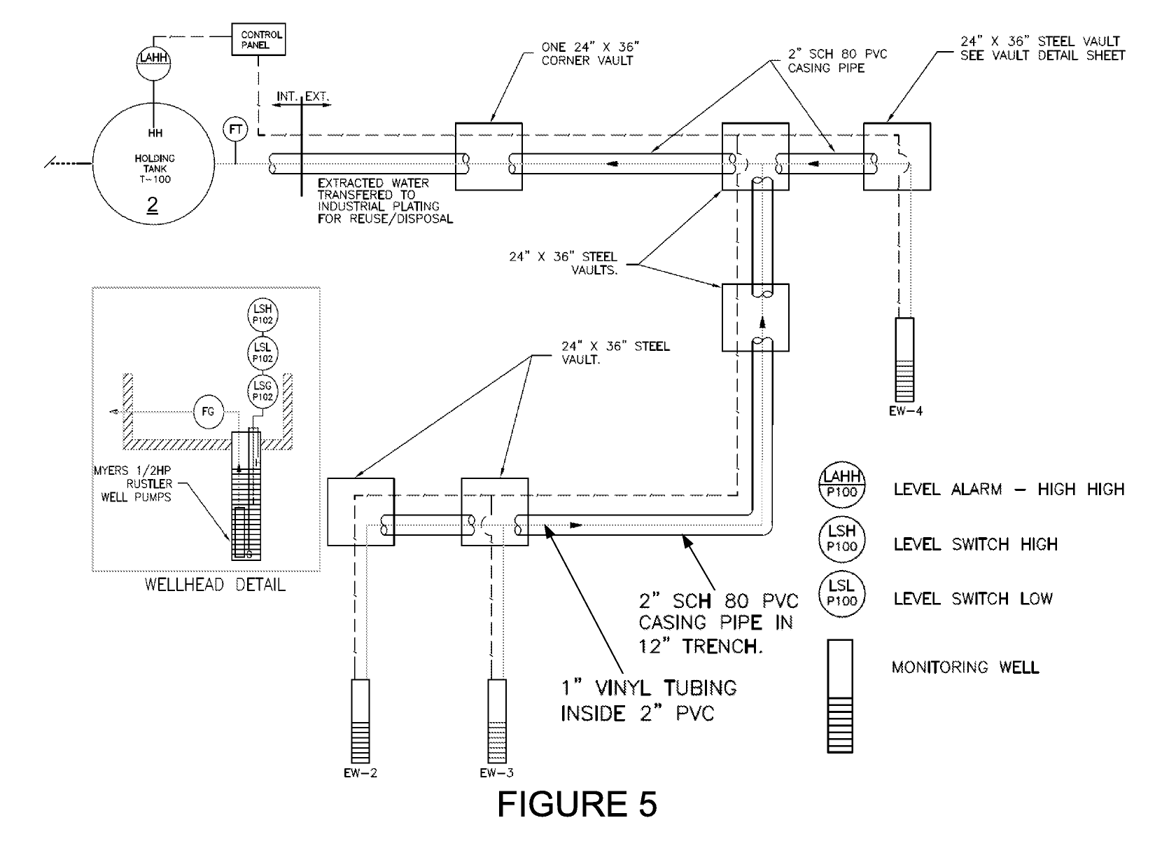

In one exemplary embodiment, the treatment tank may be 1400 gallons, with four 55-gallon drums or barrels as indicated in FIGS. 1 and 2. The drums may be elevated above the bottom of the treatment tank, with the tops above the top fluid level in the treatment tank, as seen in FIG. 3, although the tops may be below the top fluid level. Water is pumped into the top of the first drum by a pump of suitable size, where it circulates down through the iron shavings, and is piped from the bottom of the first barrel to the top of the second barrel. This is repeated for the third and fourth barrels, with the water discharged from the fourth barrel directly back into the treatment tank fluid. Tanks, pumps and barrels/containers of different sizes and configurations as needed may be used. In addition, materials other than iron shavings may be used in the flow-through treatment drums or barrels, with materials chosen based on the contaminant being removed.

The present invention may be put into place as a standalone system, or incorporated into larger-scale treatment systems or facilities. FIG. 4 shows an embodiment of the present invention where the system is for treatment of chrome-impacted groundwater through a two-phased remediation system at a chrome plating facility. A portion of the extracted groundwater (i.e., extracted through groundwater wells or monitoring wells) is used as make-up water in the facility chrome plating tanks, while the remaining portion is treated using zero-valence iron shavings through a continuous flow system.

In general, the system shown in FIG. 4 operates as follows:

1) The groundwater extraction well pump system is operated to fill a first holding tank located in the plating/stripping area. The system is designed as an automatic system, controlled by level switches in each extraction well. As long as the wells have sufficient amount of groundwater, the system works automatically. During periods of low rainfall, the extraction well pumps may have to be operated manually from the control panel.

2) A minimum of one grab sample is collected from holding tank (T-100) at least monthly for submittal for analysis. The sample is collected in appropriate laboratory-supplied sample containers. The sampled is analyzed for total and hexavalent chromium by an approved environmental laboratory as part of the monitoring process. More frequent testing and sampling may be implemented.

3) At least monthly, groundwater monitoring wells are bailed dry (manually or automatically), and the extracted groundwater transferred to the holding tank for reuse/treatment.

4) At a minimum, the readout from the flow meters for the holding tank (T-100), the discharge from the treatment tank (T-101), and from each of the extraction wells is recorded. This information typically is used by the facility owner, or its consultant, for reporting requirements to the appropriate regulatory authorities.

5) Groundwater is transferred from the holding tank (T-100) into the treatment tank (T-101) at a flow rate of 0.7 gpm. The water in the treatment tank is recirculated at a rate of 2 gpm through the series of four treatment drums containing iron shavings. Treated groundwater from the last drum (the fourth drum, as shown in FIG. 4) discharges into the treatment tank. The treatment tank and the influent pump flow rate are sized for an 8-hour hydraulic detention time, on a continuous flow operating basis.

6) Prior to discharge, treated groundwater within the treatment tank is pumped through a final drum of iron shavings (a fifth drum) which acts as a backup treatment drum for the groundwater.

7) In order to provide continuous monitoring of the quality of the treated groundwater, the Oxidation Reduction Potential (ORP) is continuously monitored. In this embodiment, ORP is monitored at the final drum (the fifth drum). Typical ORP readings are in the range of −100 to −400 mV. A chart comparing ORP to total chrome concentration may be prepared. Actions are taken based on measured ORP.

In the event that the measured ORP level reaches −115 mV, the discharge valve from the treatment tank is immediately shut to prevent discharge of treated water that is close to the discharge limit, and the facility operator or consultant is notified as soon as possible. Samples of the treatment tank effluent are collected for laboratory analysis for chromium (total and hexavalent), iron (total and dissolved), and pH by an approved environmental laboratory. If the effluent sample meets the permitted discharge limits, the tank can be discharged directly to the sewer (or the equivalent). If the effluent does not meet the permitted discharge limits, alternate disposal may need to be arranged. Prior to restarting the treatment in the treatment tank, and adding additional extracted groundwater, the iron shaving drums should be investigated to determine which drum(s) have been exhausted or may be malfunctioning, and therefore require replacement.

8) An ORP chart recorder is set up for a 7 day monitoring cycle. At the start of each work week, the chart paper is replaced and filed. The chart is dated and filed for future reference. The charts may be kept on file for as long as the treatment system is operational, or as otherwise required.

9) Treated groundwater samples are collected at least twice monthly. In one embodiment, they are collected on the first and fifteenth of each month (or the nearest business day to each). The samples are analyzed for chromium (total and hexavalent), iron (total and dissolved) and pH. Samples are to be collect in the appropriate sample containers. Sample are to be analyzed by an approved environmental laboratory, with the reports sent to the facility operator or consultants, as necessary or required.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. An apparatus for treatment of water, comprising:
a treatment tank containing water to be treated; and
one or more flow-through containers filled in whole or in part with iron shavings;
wherein water is recirculated through the flow-through containers for a period of time.

2. The apparatus of claim 1, wherein the water is recirculated through the flow-through containers to remove hexavalent chrome from the water.

3. The apparatus of claim 1, wherein there are three or more flow-through containers connected in series.

4. The apparatus of claim 1, wherein the water is discharged after treatment.

5. The apparatus of claim 1, wherein the water is process water or contaminated groundwater.

6. The apparatus of claim 1, further comprising a finishing flow-through container, wherein the water is circulated through the finishing flow-through container prior to discharge from the treatment tank.

7. The apparatus of claim 6, further comprising an ORP meter monitoring the ORP of the water being discharged.

8. A method for removal of hexavalent chromium from water, comprising the steps of:
receiving the water to be treated in a treatment tank; and
circulating the water for a period of time through two or more flow-through containers filled in whole or in part with iron shavings, wherein said flow-through containers are connected in series.

9. The method of claim 8, further comprising the step of circulating the water through a finishing flow-through container prior to discharging the water from the treatment tank.

10. The method of claim 9, further comprising the step of monitoring the ORP of the water being discharged.

11. The method of claim 10, wherein operation of the treatment tank is suspended if the ORP of the water being discharged exceeds a threshold level.
